(19) United States
(12) Patent Application Publication
(10) Pub. No.: US 2019/0252130 A1
(43) Pub. Date: Aug. 15, 2019

(54) ELECTROCHEMICAL DEVICE

(71) Applicant: TDK CORPORATION, Tokyo (JP)

(72) Inventors: Hiroaki HASEGAWA, Tokyo (JP); Hidetake ITOH, Tokyo (JP); Yoshihiko OHASHI, Tokyo (JP); Yuji YOSHINO, Tokyo (JP); Kazunori YOSHIKAWA, Tokyo (JP); Kiyonori HINOKI, Tokyo (JP)

(73) Assignee: TDK CORPORATION, Tokyo (JP)

(21) Appl. No.: 16/265,134

(22) Filed: Feb. 1, 2019

(30) Foreign Application Priority Data
Feb. 15, 2018 (JP) 2018-024947

(51) Int. Cl. H01G 11/26; H01G 11/30; H01G 11/70; H01M 10/0585; H01M 10/052; H01M 2/30

(52) U.S. Cl. CPC H01G 11/26; H01G 11/30; H01M 2/30; H01M 10/0585; H01M 10/052; H01G 11/70

(57) ABSTRACT

An electrochemical device excellent in connection reliability is provided. An EDLC 2 includes: an element body 10 in which a pair of inner electrodes 16, 26 are laminated so as to sandwich a separator sheet 11; an exterior sheet 4 covering the element body 10; seal parts 40, 42 sealing peripheral parts of the exterior sheet 4 so that the element body 10 is immersed in an electrolyte; and lead terminals 18, 28 extending outward from the seal parts 40, 42 of the exterior sheet 4. At least one surface of the lead terminals 18, 28 is etched so as to form unevenness 180, 280.

### BACKGROUND OF THE INVENTION

### Field of the Invention

The present invention relates to an electrochemical device which is preferably used as an electric double layer capacitor (EDLC) and the like.

### Description of the Related Art

For example, as also shown in JP-A-2015-79836 described below, an ultrathin electrochemical device is gathering attention according to application in IC cards or the like. In this kind of electrochemical device, there is a case that an ACF (Anisotropic Conductive Film) or ACP (Anisotropic Conductive Paste) is used to connect lead terminals to a circuit substrate of an IC card or the like. The reason is that a thin IC card or the like that suppresses thickness of a connection part and makes use of thinness of the device to the maximum is obtained. However, in this connection form, there is concern that connection strength of the connection part is lowered or connection resistance is increased.

### SUMMARY OF THE INVENTION

The present invention is accomplished based on this circumstance, and the purpose is to provide an electrochemical device that is excellent in connection reliability.

In order to achieve the above purpose, the electrochemical device of a first aspect of the present invention is an electrochemical device including:

an element body in which a pair of inner electrodes are arranged so as to sandwich a separator sheet;

an exterior sheet covering the element body;

seal parts sealing peripheral parts of the exterior sheet for immersing the element body in an electrolyte; and

lead terminals extending outward from the seal parts of the exterior sheet;

wherein at least one surface of the lead terminals is etched to form unevenness.

In the electrochemical device of the first aspect of the present invention, at least one surface of the lead terminals is etched to form unevenness. Therefore, a surface area of the lead terminal is increased, and an adhesive area between resin contained in the ACF or ACP and the lead terminal is increased. As a result, due to an anchor effect, adhesion between the circuit substrate and the lead terminal is enhanced, and the circuit substrate and the lead terminal are firmly connected via the resin. Accordingly, connection strength between the circuit substrate and the lead terminal is improved, and the connection reliability can be improved.

In addition, the surface area of the lead terminal increases and thus a contact area between conductive particles contained in the ACF or ACP and the lead terminals increases. As a result, the connection resistance between the circuit substrate and the lead terminal decreases and the connection reliability can be improved.

In order to achieve the above purpose, the electrochemical device of a second aspect of the present invention is an electrochemical device including:

an element body in which a pair of inner electrodes are arranged so as to sandwich a separator sheet;

an exterior sheet covering the element body;

seal parts sealing peripheral parts of the exterior sheet for immersing the element body in an electrolyte; and

lead terminals extending outward from the seal parts of the exterior sheet;

wherein spectral reflectance of at least one surface of the lead terminals is 70% or less according to the SCI (Specular Component Include) method.

In the electrochemical device of the second aspect of the present invention, the spectral reflectance of at least one surface of the lead terminals is 70% or less according to the SCI method. The spectral reflectance of the surface of the lead terminal changes corresponding to a surface state of the lead terminal. For example, it is considered that specified unevenness is formed on at least one surface of the lead terminals when the spectral reflectance is 70% or less according to the SCI method. In this case, the surface area of the lead terminal is increased, and as described above, due to the anchor effect, the connection strength between the circuit substrate and the lead terminal is improved and the connection reliability can be improved. In addition, the contact area between the conductive particles contained in the ACF or ACP and the lead terminal increases and the connection resistance between the circuit substrate and the lead terminal decreases, and the connection reliability can be improved.

Preferably, at least one surface of the lead terminals is chemically etched. By this configuration, compared with a case that the unevenness is formed on at least one surface of the lead terminals by a physical approach, the specified unevenness that can improve the connection reliability can be formed.

Preferably, the lead terminals are formed by aluminum or an aluminum alloy.

Preferably, current collector layers of the inner electrodes are formed continuously and integrally with the lead terminals. By this configuration, the thickness of the lead terminals is easily reduced.

In addition, it is preferable that a surface similar to the surface of the lead terminal (the spectral reflectance is 70% or less according to the SCI method) is also formed on the surface of the current collector layer. In this case, the surface area of the current collector layer is increased, and the contact area with an active layer laminated on the current collector layer is increased. As a result, due to the anchor effect, the adhesion between the active layer and the current collector layer is enhanced, and the connection strength between the active layer and the current collector layer can be improved.

Preferably, the thickness of the lead terminals is 60 μm or less. By this configuration, thinning of the device can be realized effectively.

Preferably, support tabs are further provided which are comprised of a portion of the peripheral parts of the exterior sheet extending outwardly from the seal parts. By this configuration, the lead terminals arranged on the support tabs can be effectively protected.

### BRIEF DESCRIPTION OF THE DRAWINGS

FIG. 1A is a perspective view of an electric double layer capacitor of one embodiment of the present invention;

FIG. 1B is a perspective view of an electric double layer capacitor of another embodiment of the present invention;

FIG. 2A is a schematic cross-sectional view taken along a line IIA-IIA of FIG. 1A;

FIG. 2B is an enlarged cross-sectional view of a main part of a seal part shown in FIG. 2A;

FIG. 2C is an enlarged cross-sectional view of a main part taken along a line IIC-IIC of FIG. 1A;

FIG. 2D is an enlarged cross-sectional view of a main part taken along a line IID-IID of FIG. 1A;

FIG. 2E is an enlarged cross-sectional view of a main part of a variation example of the electric double layer capacitor shown in FIG. 2D;

FIG. 3 is a cross-sectional view showing a manufacturing method example of the electric double layer capacitor shown in FIG. 2A;

FIG. 4A is a schematic perspective view showing the manufacturing method example corresponding to FIG. 3;

FIG. 4B is a perspective view showing a process after FIG. 4A;

FIG. 5 is a perspective view of an electric double layer capacitor of another embodiment of the present invention;

FIG. 6 is a cross-sectional view of a main part taken along a line VI-VI of FIG. 5;

FIG. 7A is a perspective view of an electric double layer capacitor of still another embodiment of the present invention;

FIG. 7B is a perspective view of a variation example of the electric double layer capacitor shown in FIG. 7A;

FIG. 8 is a perspective view of an electric double layer capacitor of still another embodiment of the present invention; and

FIG. 9 is a drawing showing a relation between measurement wavelengths of a spectral colorimeter and spectral reflectance of the surface of a lead terminal.

### DETAILED DESCRIPTION OF THE PREFERRED EMBODIMENTS

The present invention is described below based on the embodiments shown in the drawings.

### First Embodiment

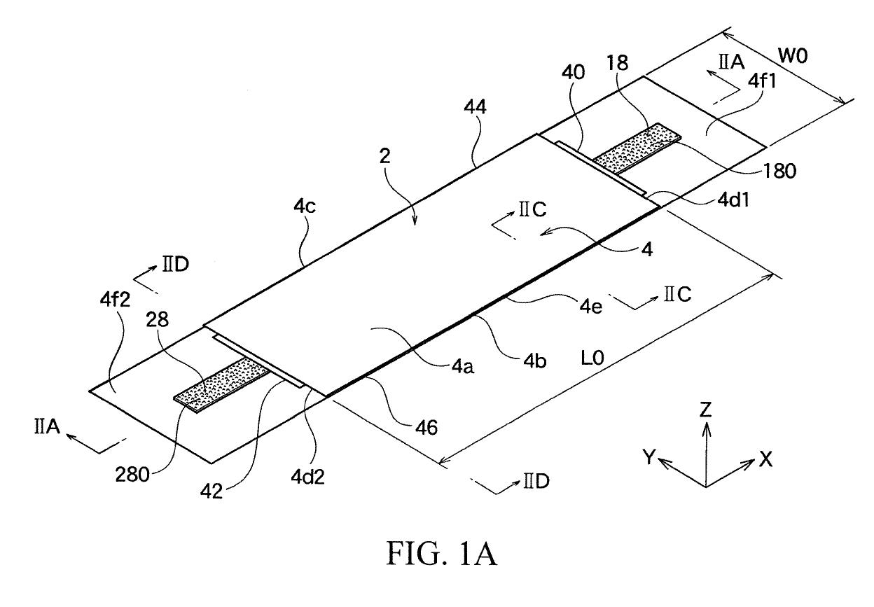

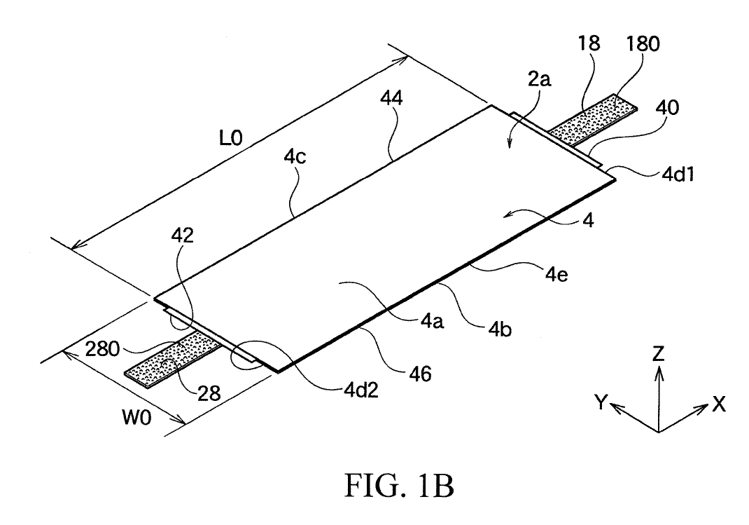

As shown in FIG. 1A, an electric double layer capacitor (EDLC) 2 used as an electrochemical device of one embodiment of the present invention includes an exterior sheet 4. The exterior sheet 4 includes a front sheet 4a and a back sheet 4b formed by folding a piece of sheet at a folded-back peripheral part 4c. Moreover, the exterior sheet 4 may also be configured by sticking independent upper and lower sheets together without folding back the front sheet 4a and the back sheet 4b.

In this embodiment, the exterior sheet 4 has, but is not limited to, a rectangular shape in which a length L0 in an X-axis direction is longer than a length W0 in a Y-axis direction, and may also have a square shape or other polygonal shapes, or a circle shape, an ellipse shape or other shapes. In the embodiment, a direction in which the front sheet 4a and the back sheet 4b of the exterior sheet 4 overlap is set as a thickness direction (Z-axis direction), and directions orthogonal to this direction are set as X-axis and Y-axis.

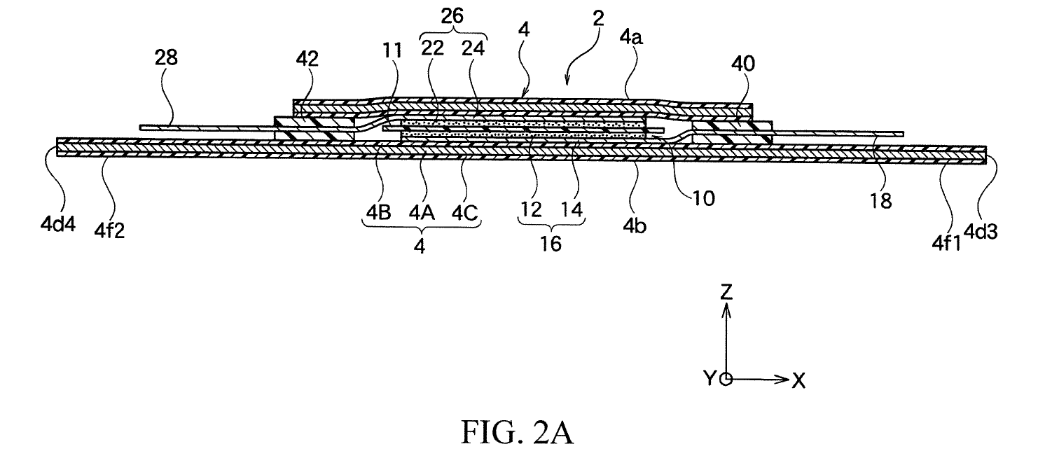

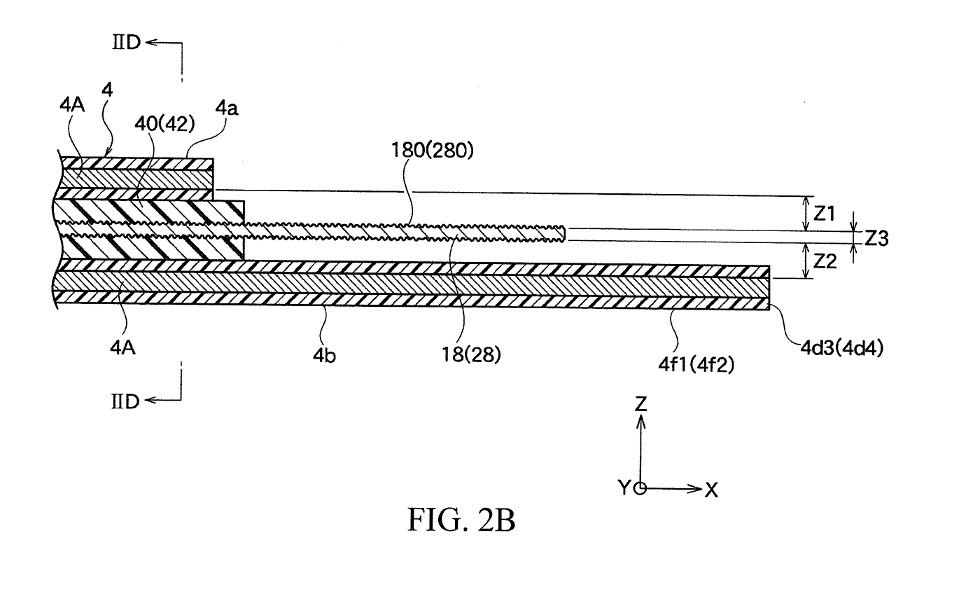

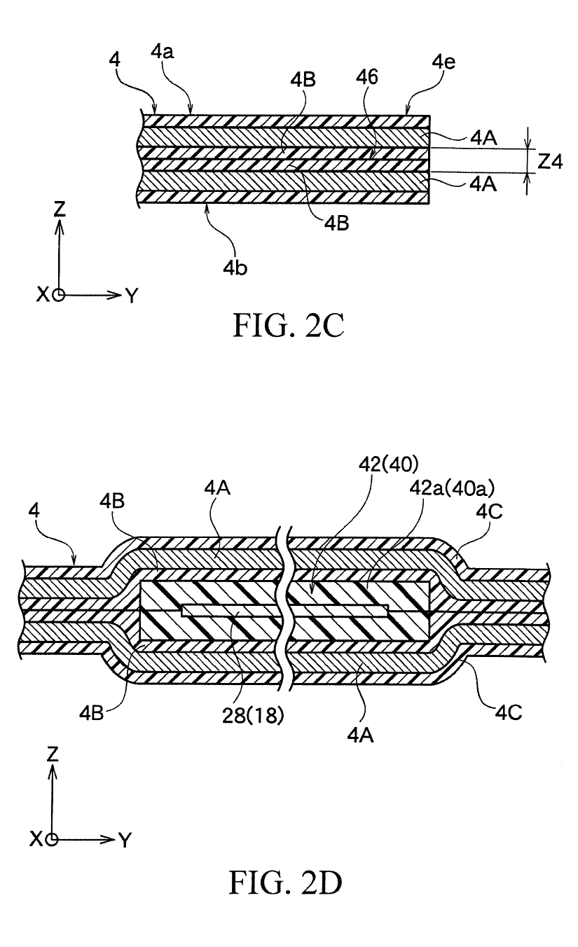

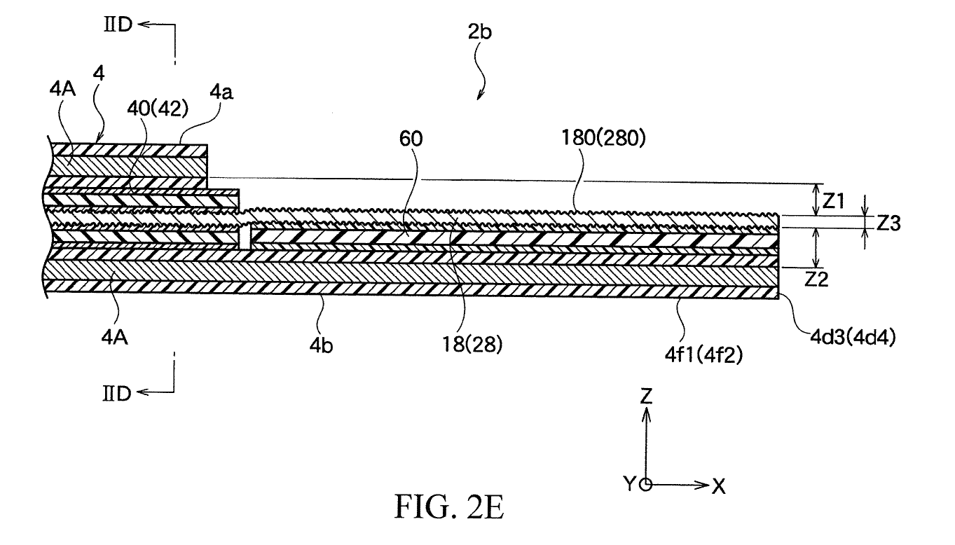

As shown in FIG. 2A, an element body 10 is housed in the exterior sheet 4. The element body 10 corresponds to an element of the electric double layer capacitor, and a single capacitor element is accommodated in the exterior sheet 4 in the present embodiment.

In the element body 10, a pair of first inner electrode 16 and second inner electrode 26 are laminated (arranged) so as to sandwich a separator sheet 11 which is permeated with an electrolyte. One of the first inner electrode 16 and the second inner electrode 26 is a positive electrode and the other one is a negative electrode, but the configurations are the same. The first inner electrode 16 and the second inner electrode 26 have a first active layer 12 and a second active layer 22 which are laminated so as to respectively contact with mutually opposite surfaces of the separator sheet 11. In addition, the first inner electrode 16 and the second inner electrode 26 have a first current collector layer 14 and a second current collector layer 24 which are laminated so as to respectively contact with the respective active layers 12, 22.

The separator sheet 11 is configured in a manner that the inner electrodes 16 and 26 are electrically insulated and the electrolyte can penetrate, and is configured by an electric insulation porous sheet for example. The electric insulation porous sheet includes a monolayer body or a laminated body of a film containing polyethylene, polypropylene or polyolefin, or a stretched film of mixture of the above resins, or a fiber non-woven fabric consisting of at least one kind of constituent material selected from a group consisting of cellulose, polyester and polypropylene. The thickness of the separator sheet 11 is, for example, about 5-50 μm.

Generally, the current collector layers 14, 24 are not particularly limited as long as a material having a high conductivity is used, but a metal material of low electric resistance is preferably used, for example, a sheet of copper, aluminum, nickel or the like is used. The respective thickness of the current collector layers 14, 24 is, for example, about 10-100 μm, preferably 60 μm or less, more preferably 15-60 μm. The width in the Y-axis direction of the current collector layers 14, 24 is preferably 2-10 mm, and is preferably smaller than the width in the Y-axis direction of the separator sheet 11. The current collector layers 14, 24 are preferably arranged in the center of the Y-axis direction of the separator sheet 11.

The active layers 12, 22 contain an active material and a binder, preferably containing a conductive assistant. The active layers 12, 22 are laminated and formed on the surfaces of the sheets constituting the respective current collector layers 14, 24.

The active material includes various porous bodies having electronic conductivity, for example, carbon materials such as activated carbon, natural graphite, artificial graphite, meso-carbon microbeads, meso-carbon fiber (MCF), cokes, glass-like carbon, organic compound fired body and the like. The binder is not particularly limited as long as the active material, preferably the conductive assistant can be fixed on the sheets constituting the current collector layers, and various binding agents can be used. The binder includes, for example, a fluorine resin such as polyvinylidene fluoride (PVDF), polytetrafluoroethylene (PTFE) and the like, a mixture of styrene-butadiene rubber (SBR) and water-soluble polymer (carboxymethyl cellulose, polyvinyl alcohol, sodium polyacrylate, dextrin, gluten or the like), or the like.

The conductive assistant is a material added to improve the electronic conductivity of the active layers 12, 22. The conductive assistant includes, for example, carbon materials such as carbon black, acetylene black and the like, fine metal powder of copper, nickel, stainless, iron and the like, a mixture of carbon material and fine metal powder, and a conductive oxide such as ITO.

The respective thickness of the active layers 12, 22 is preferably, for example, about 1-100 μm. The active layers 12, 22 are formed on the surfaces of the current collector layers 14, 24 with a surface area equivalent to or less than the separator sheet 11 on the surfaces of the respective current collector layers 14, 24. The active layers 12, 22 can be manufactured by a publicly known method.

In this embodiment, the “positive electrode” refers to an electrode on which anions in the electrolyte are adsorbed when a voltage is applied to the electric double layer capacitor, and the “negative electrode” refers to an electrode on which cations in the electrolyte are adsorbed when a voltage is applied to the electric double layer capacitor. Moreover, when a recharge is performed after a voltage is applied to the electric double layer capacitor in a specified positive and negative direction to charge once, the charge is usually performed in the same direction as the beginning, and it is rare to apply the voltage in the opposite direction to charge.

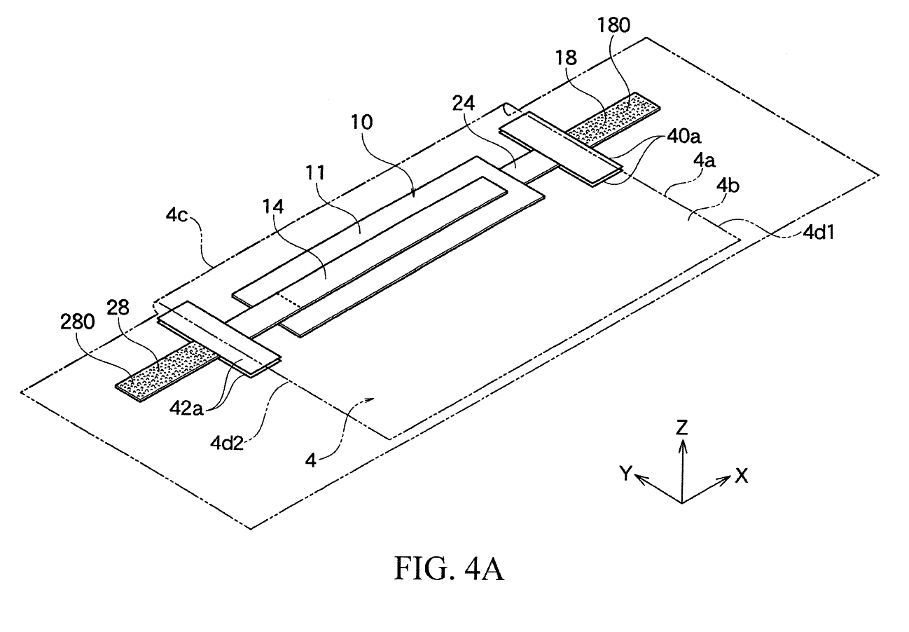

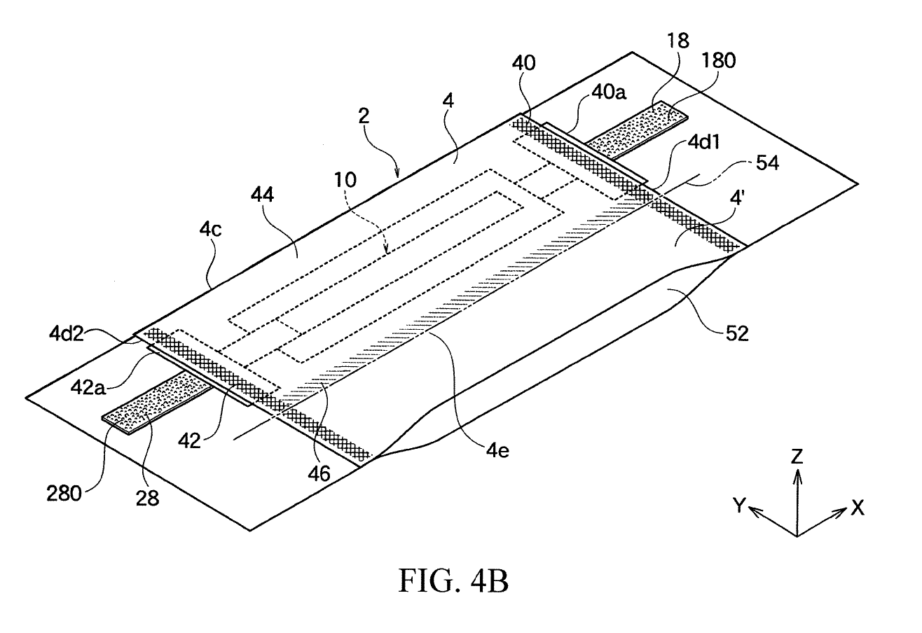

It is preferable that the exterior sheet 4 consists of a material that does not let the electrolyte described later permeate and is integrated with the peripheral parts of the exterior sheet 4 or a sealing tape 40a (the same applies to a case in which 42a is included) shown in FIG. 4A by heat sealing. In view of workability, the sealing tape 40a is preferably in a tape shape such as an adhesive tape. However, without being limited to tape, the sealing tape 40a may also be a coatable sealant resin or be in any form as long as it is bondable by melting with heat.

In addition, the exterior sheet 4 is configured by a sheet that seals the element body 10 and prevents air and moisture from entering the inside of the exterior sheet 4. Specifically, the exterior sheet 4 may be a single-layer sheet but is preferably a multilayer sheet laminated as shown in FIG. 2A so as to sandwich a metal sheet 4A by an inner layer 4B and an outer layer 4C.

The metal sheet 4A is preferably configured, for example, by aluminum (Al), stainless and the like; the inner layer 4B is configured by an electric insulation material, and is preferably configured by a material similar to polypropylene or the like that hardly reacts with the electrolyte and that is capable of heat sealing. In addition, the outer layer 4C is configured, for example, by PET, PC, PES, PEN, PI, fluorine resin, PE, polybutylene terephthalate (PBT) and the like without being particularly limited. The thickness of the exterior sheet 4 is preferably 5-150 μm.

In this embodiment, the bearing ability of the exterior sheet 4 is 390-1275 N/mm², preferably 785-980 N/mm² in JIS Z2241. In addition, the hardness of the exterior sheet is 230-480, preferably 280-380 in vickers hardness (Hv) (JIS 2244). From this viewpoint, the metal sheet 4A of the exterior sheet 4 is preferably a stainless steel SUS304 (BA), SUS304 (1/2H), SUS304 H, SUS301 BA, SUS301 (1/2H), and SUS301 (3/4H) specified in JIS.

Lead terminals 18, 28 are conductive members functioning as current input and output terminals for the current collector layers 14, 24 and have a rectangular plate shape. In this embodiment, the lead terminals 18, 28 are respectively formed by a sheet integrated with the conductive sheets respectively constituting the current collector layers 14, 24, and may have the same thickness as the current collector layers 14, 24. By this configuration, the thickness of the lead terminals is easily reduced.

However, the respective lead terminals 18, 28 may also be formed by conductive members separated from the current collector layers 14, 24 and be electrically connected to the current collector layers 14, 24. In this case, the thickness of the respective lead terminals 18, 28 may be different from the thickness of the current collector layers 14, 24, and is, about 10-100 μm for example, preferably 60 μm or less, more preferably 20-60 μm. By this configuration, thinning of the device can be realized effectively. Preferably, the lead terminals 18, 28 are formed by aluminum or an aluminum alloy.

As shown in FIG. 2A, the respective lead terminals 18, 28 extend along support tabs 4f1, 4f2 from the mutually opposite sides in the X-axis direction of the element body 10, and the inside of the exterior sheet 4 is sealed by a first seal part 40 and a second seal part 42. The support tabs 4f1, 4f2 are formed by outward extending a portion of the peripheral parts of the exterior sheet 4 located in the seal parts 40, 42. In other words, the leading end parts of the exterior sheet 4 are located outside the leading end parts of the lead terminals 18, 28 along a extending direction of the lead terminals 18, 28, and serve as the support tabs 4f1, 4f2.

The first seal part 40 and the second seal part 42 are formed by integrating sealing tapes 40a, 42a shown in FIG. 4A and FIG. 4B described later and the inner layer 4B of the exterior sheet 4 shown in FIG. 2A by heat sealing. That is, as shown in FIG. 2D, a portion of the inner layer (resin) 4B formed on an inner peripheral surface of the exterior sheet 4 is adhered to the surfaces on two sides of the lead terminals 18, 28 along with the sealing tapes 40a, 42a in the Y-axis direction to form a heat welding part, and sealing performance in the first seal part 40 and the second seal part 42 is improved.

In addition, as shown in FIG. 1A, in a third seal part 44 where the lead terminals 18, 28 are not formed (from which the lead terminals 18, 28 do not extend), the inner layer 4B of the exterior sheet 4 is folded at the folded-back peripheral part 4c of the exterior sheet 4, and is fused and integrated by heat sealing. Similarly, in a fourth seal part 46 where the lead terminals 18, 28 are not formed (from which the lead terminals 18, 28 do not extend), as shown in FIG. 2C, the inner layer 4B of a side peripheral part 4e in the front sheet 4a and the back sheet 4b of the exterior sheet 4 is fused and integrated by heat sealing.

As shown in FIG. 1A, one end of the third seal part 44 and one end of the fourth seal part 46 are respectively formed continuously so as to connect two sides in the Y-axis direction of the first seal part 40. The second seal part 42 is continuously formed so as to connect the other end of the third seal part 44 and the other end of the fourth seal part 46. Therefore, the inside of the exterior sheet 4 is sealed well so as to be isolated from the outside of the exterior sheet 4.

A space sandwiched in the exterior sheet 4 for sealing the element body 10 by the seal parts 40, 42, 44 and 46 is filled with electrolyte (not shown), and a part of the electrolyte is impregnated inside the active layers 12, 22 and the separator sheet 11 shown in FIG. 2A.

The electrolyte made by dissolving an electrolyte salt in an organic solvent is used. The electrolyte salt is preferably, for example, quaternary ammonium salt such as tetraethyl ammonium tetrafluoroborate (TEA⁺ BF⁴⁻) and triethyl monomethyl ammonium tetrafluoroborate (TEMA⁺ BF⁴⁻) and the like, ammonium salts, amine salts, amidine salts or the like. Further, one kind of these electrolyte salts may be used independently, or two or more kinds may be used in combination.

In addition, a publicly known solvent can be used as the organic solvent. The organic solvent preferably includes, for example, propylene carbonate, ethylene carbonate, dimethyl carbonate, methyl ethyl carbonate, diethyl carbonate, γ-butyrolactone, dimethylformamide, sulfolane, acetonitrile, propionitrile, methoxy acetonitrile and the like. These organic solvents may be used independently, or two or more kinds may be mixed in any ratio to be used.

The leading ends of the respective lead terminals 18, 28, as shown in FIG. 2A, respectively extend through the first seal part 40 and the second seal part 42 to the outside of the first seal part 40 and the second seal part 42. The first seal part 40 and the second seal part 42 are portions where the respective lead terminals 18, 28 extend outside, and the sealing performance is particularly required compared with the third seal part 44 and the fourth seal part 46.

In a location of the seal parts 40, 42 where the lead terminals 18, 28 extend, when a first thickness of the seal parts 40, 42 from the surfaces of the lead terminals 18, 28 to the metal sheet 4A on the front surface side (upper surface side) is set to Z1, a second thickness of the seal parts 40, 42 from the back surface of the lead terminals 18, 28 to the metal sheet 4A on the back surface side is set to Z2, and the thickness of the lead terminals 18, 28 is set to Z3, the following formula is established. That is, Z1+Z2 is 60 μm or less, preferably 15-60 μm, and (Z1+Z2)/Z3 is 0.5 or more and 6.0 or less.

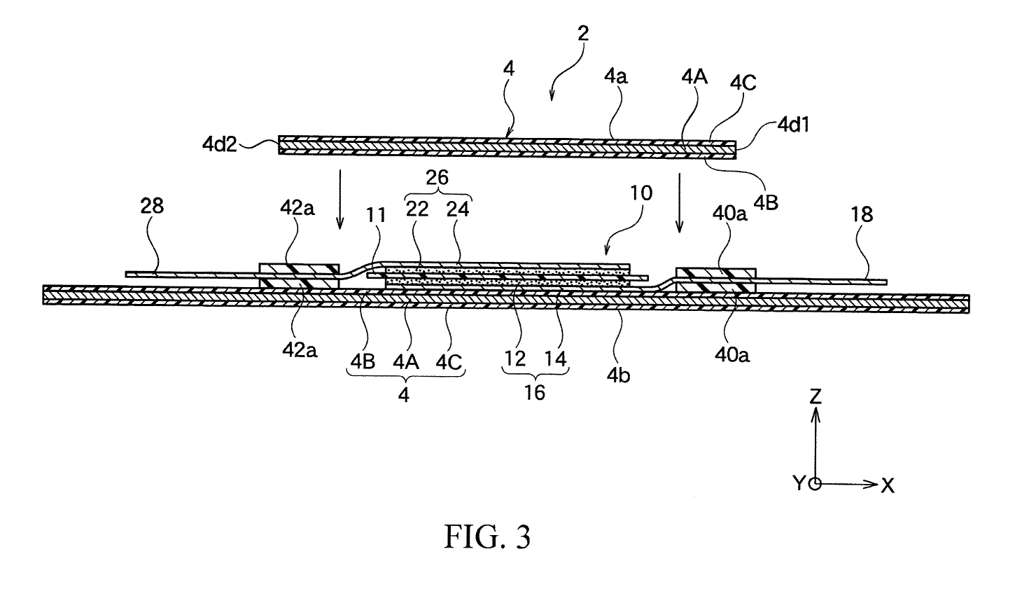

The first thickness Z1 and the second thickness Z2 are substantially the same but not necessarily always the same in this embodiment. For example, the first thickness Z1 is formed by a thickness corresponding to the sealing tape 40a and the inner layer 4B shown in FIG. 3, the second thickness Z2 is formed by a thickness corresponding to the inner layer 4B shown in FIG. 3, wherein a thickness corresponding to the first thickness Z1 and a thickness corresponding to the first thickness Z2 may be reversed.

In this embodiment, as shown in FIG. 2B, the surfaces of the lead terminals 18, 28 are etched so that specified unevenness 180, 280 is formed. Therefore, the surfaces of the lead terminals 18, 28 are roughened, and a plenty of fine unevenness 180, 280 is formed on the surfaces of the lead terminals 18, 28. The height (depth) of the unevenness 180, 280 is preferably 0.5-45 μm, more preferably 0.5-10 μm. In addition, the shape of the unevenness 180, 280 is a random shape.

The unevenness 180, 280 is formed along a longitudinal direction of the lead terminals 18, 28 and over the entire surface on both surfaces of the lead terminals 18, 28.

In this embodiment, the unevenness 180, 280 is formed by chemical etching on the surfaces of the lead terminals 18, 28. The etching treatment can be performed by immersing metal foils constituting the lead terminals 18, 28 in a solution (etching solution) of acid (hydrofluoric acid) or alkali (sodium hydroxide) or the like for a predetermined time.

The etching conditions can include, for example, a type or concentration, amount, temperature of the etching solution, or an etching time and the like. By controlling these parameters or by appropriately changing materials constituting the lead terminals 18, 28, or thickness, strength, purity and the like, a degree of the unevenness 180, 280 (magnitude of the spectral reflectance described later) of the surfaces of the lead terminals 18, 28 can be controlled. For example, when the etching time is longer, the degree of the unevenness 180, 280 of the surfaces of the lead terminals 18, 28 can be increased.

The etching to the lead terminals 18, 28 is preferably performed in a range in which mechanical strength of the lead terminals 18, 28 is not reduced. Furthermore, the degree of the unevenness 180, 280 (magnitude of the spectral reflectance described later) can also be controlled by performing a pressurizing treatment with a calender roll and the like. For example, when the pressurizing treatment is performed by the calender roll, the calender roll conditions can include pressure, temperature or the like. If the pressure of the calender roll is increased or the temperature is raised, the degree of the unevenness 180, 280 of the surfaces of the lead terminals 18, 28 can be reduced.

Moreover, electrochemical etching may be performed on the surfaces of the lead terminals 18, 28. In this case, by controlling a current density, the degree of the unevenness 180, 280 (magnitude of the spectral reflectance described later) of the surfaces of the lead terminals 18, 28 can be controlled. In addition, as long as an action similar to the chemical etching is obtained, the unevenness 180, 280 may also be formed by applying other roughening treatments (for example, etching using a physical approach) to the lead terminals 18, 28. However, from the viewpoint of easily forming the unevenness 180, 280 on the lead terminals 18, 28, chemical etching is most preferable.

Accordingly, when the unevenness 180, 280 is formed on the surfaces of the lead terminals 18, 28, before and after the formation of the unevenness 180, 280, a surface state of the lead terminals 18, 28 is changed, and luster or gloss, surface roughness, or the spectral reflectance of the surfaces of the lead terminals 18, 28 is changed. The spectral reflectance of the surfaces of the lead terminals 18, 28 in this embodiment is lower than the spectral reflectance of the surfaces of the lead terminals on which the specified unevenness 180, 280 is not formed.

In this embodiment, the spectral reflectance of the surfaces of the lead terminals 18, 28 when measured in the range of a measurement wavelength of 360 nm-740 nm using a spectral colorimeter is preferably 70% or less, more preferably 60% or less, particularly preferably 35%-60% according to the SCI (Specular Component Include) method.

It is considered that when the spectral reflectance of the surfaces of the lead terminals 18, 28 is in the above range, the specified unevenness (the unevenness for which the spectral reflectance is in a specified range) 180, 280 is formed on the surfaces of the lead terminals 18, 28.

In this embodiment, in addition to the lead terminals 18, 28, the above-described unevenness 180, 280 is also formed on the surfaces of the current collector layers 14, 24 formed continuously and integrally with the lead terminals 18, 28. The unevenness 180, 280 formed on the surfaces of the current collector layers 14, 24 has the same characteristics as the unevenness 180, 280 formed on the surfaces of the lead terminals 18, 28.

In the EDLC 2 of this embodiment, the spectral reflectance of the surfaces of the lead terminals 18, 28 is in a specified range. Therefore, the surface area of the lead terminals 18, 28 is increased, and the adhesive area between the resin contained in ACF or ACP and the lead terminals 18, 28 is increased. As a result, due to the anchor effect, the adhesion between the circuit substrate and the lead terminals 18, 28 is enhanced, and the circuit substrate and the lead terminals 18, 28 are firmly connected via the resin. Accordingly, the connection strength between the circuit substrate and the lead terminals 18, 28 is improved, and the connection reliability can be improved.

In addition, the surface area of the lead terminals 18, 28 is increased, so that the contact area between the conductive particle contained in the ACF or ACP and the lead terminals 18, 28 is increased. As a result, the connection resistance between the circuit substrate and the lead terminals 18, 28 decreases and the connection reliability can be improved.

In addition, the surfaces of the lead terminals 18, 28 are chemically etched. By this configuration, compared with a case that the unevenness 180, 280 is formed on the surfaces of the lead terminals 18, 28 by a physical approach, the specified unevenness 180, 280 that can improve the connection reliability can be formed.

In addition, the current collector layers 14, 24 of the inner electrodes 16, 26 are formed continuously and integrally with the lead terminals 18, 28. By this configuration, the thickness of the lead terminals 18, 28 is easily reduced.

In addition, surfaces similar to the surfaces of the lead terminals 18, 28 (the spectral reflectance is 70% or less in the SCI method) are also formed on the surfaces of the current collector layers 14, 24. In this case, the surface area of the current collector layers 14, 24 is increased, and the contact area with the active layers 12, 22 laminated on the current collector layers 14, 24 is increased. As a result, due to the anchor effect, the adhesion between the active layers 12, 22 and the current collector layers 14, 24 is enhanced, and the connection strength between the active layers 12, 22 and the current collector layers 14, 24 can be improved.

In addition, in the EDLC 2 of this embodiment, the first lead terminal 18 and the second lead terminal 28 of the element body 10 extend along the longitudinal direction (X-axis direction) of the EDLC 2 to opposite sides. Therefore, the width in the Y-axis direction of the EDLC 2 can be reduced, the thickness of the first seal part 40 and the second seal part 42 can be reduced to a required minimum, and the thickness of the entire EDLC 2 can also be reduced. Therefore, miniaturization and thinning of the EDLC 2 can be realized.

In addition, in the EDLC 2 of this embodiment, for example, the first lead terminal 18 is set as a positive electrode and the second lead terminal 28 is set as a negative electrode, and both of the terminals are connected to the element body 10 immersed in the electrolyte. In the EDLC, it is determined that a withstand voltage of a single element is about 2.85 V at the maximum, and the elements may be connected in series in order to improve the withstand voltage depending on the application. The EDLC 2 of this embodiment is extremely thin and has a sufficient withstand voltage, and thus can be appropriately used as a battery built in thin electronic components such as an IC card or the like.

In addition, in this embodiment, the thickness Z3 of the lead terminals 18, 28 is 60 μm or less, preferably 40 μm or less. A lifetime of the device can be lengthened by reducing the thickness Z3. However, in order to maintain the strength of the lead terminals, the thickness Z3 of the lead terminals is preferably 20 μm or more.

As shown in FIG. 2C, in a location of the seal part 46 (the same applies to the seal part 44) where the lead terminal is not formed, a thickness Z4 of the seal part 46 from the metal sheet 4A on the front surface side (upper surface side) to the metal sheet 4A on the back surface side is preferably 50 μm or less. By this configuration, a diffusion of the electrolyte from the seal part 46 where the lead terminal is not formed can also be suppressed, and the lifetime of EDLC 2 can be further lengthened. Moreover, the thickness of the seal parts is preferably 10 μm or more from the viewpoint of improving the sealing performance.

In this embodiment, as shown in FIG. 2B, the leading end parts 4d3, 4d4 of the back sheet 4b are located outside the leading end parts of the lead terminals 18, 28 along the extending direction (X-axis direction) of the lead terminals 18, 28, and serve as the support tabs 4f1, 4f2. The leading end parts of the front sheet 4a are located inside the leading end parts of the lead terminals 18, 28 along the extending direction of the lead terminals 18, 28. The support tabs 4f1, 4f2 are provided and thereby the lead terminals 18, 28 arranged thereon can be protected effectively.

Next, an example of manufacturing method of the EDLC 2 in which the current collector layers 14, 24 of the inner electrodes 16, 26 are formed continuously and integrally with the lead terminals 18, 28 is described using FIG. 3-FIG. 4B.

As shown in FIG. 3 and FIG. 4A, firstly, the element body 10 is manufactured. In order to manufacture the element body 10, a metal foil which forms the current collector layer 14 and the lead terminal 18 and the metal foil which forms the current collector layer 24 and the lead terminal 28 are prepared, and these metal foils are immersed in the etching solution for a predetermined time to be subjected to chemical etching. Then, in locations corresponding to the current collector layers 14, 24 of the metal foils subjected to chemical etching, the active layers 12, 22 are laminated to produce the electrodes 16, 26. The portions within the metal foils where the current collector layers 14, 24 are not formed become the lead terminals 18, 28.

Next, the tape 40a is pasted on a boundary part of the electrode 16 and the lead terminal 18. In addition, the tape 42a is attached on the boundary part of the electrode 26 and the lead terminal 28. Then, the separator sheet 11 is arranged between the electrode 16 and the electrode 26.

In the respective lead terminals 18, 28, in locations in the X-axis direction which become the first seal part 40 and the second seal part 42 described above, the sealing tapes 40a and 42a are respectively adhered to the surface on one side or to both sides of the respective terminals 18, 28. The width in the Y-axis direction of the tapes 40a and 42a is longer than the width in the Y-axis direction of the lead terminals 18, 28.

Next, the exterior sheet 4 is folded at the folded-back peripheral part 4c and the element body 10 is covered by the front sheet 4a and the back sheet 4b of the sheet 4, so that the entire element body 10 is covered. Moreover, the exterior sheet 4 is formed long in the Y-axis direction in advance. The width in the X-axis direction of the front sheet 4a of the exterior sheet 4 is adjusted in a manner that leading end parts 4d1, 4d2 in the X-axis direction of the front sheet 4a are respectively located inside the tapes 40a, 42a in the X-axis direction. Moreover, the exterior sheet 4 may also be configured by sticking independent upper and lower sheets together without folding the front sheet 4a and the back sheet 4b.

Next, as shown in FIG. 4B, in order to form the first seal part 40 and the second seal part 42, in a location where the tapes 40a, 42a are sandwiched by the front sheet 4a and the back sheet 4b, heating and pressurizing are performed by a heat fusion jig from the outside in the Z-axis direction of the sheets 4a. At this time, the sealing tapes 40a, 42a are adhered to and integrated with the inner layer 4B of the exterior sheet 4 as an adhesive resin that flows because of pressurizing and heating, and become the seal parts 40 and 42 after solidification. During the fusion of the tapes 40a, 42a, it is preferable that the resin constituting the tapes 40a, 42a overflows and covers an exposed surface of the metal sheet 4A located in the leading end parts 4d1, 4d2 in the X-axis direction of the front sheet 4a. The reason is to prevent a short-circuit failure.

Moreover, before and after that, the folded-back peripheral part 4c of the exterior sheet 4 is pressurized and heated, and the third seal part 44 is formed. Next, the electrolyte is injected from an open end 52 of the exterior sheet 4 where the fourth seal part 46 is not formed; after that, a jig similar to the jig for forming the third seal part 44 is used to form the last fourth seal part 46 is formed by heat sealing. After that, the exterior sheet 4 is cut off along a cutting line 54 outside the fourth seal part 46 and the extra exterior sheet 4 is removed, thereby obtaining the EDLC 2 of this embodiment.

In this embodiment, the first seal part 40 is formed by heat sealing (heating and pressurizing) the sealing tape 40a stuck to the first lead terminal 18 with the inner layer 4B of the exterior sheet 4. In addition, the second seal part 42 is similarly formed by heat sealing (heating and pressurizing) the sealing tape 42a stuck to the second lead terminal 28 with the inner layer 4B of the exterior sheet 4.

In this embodiment, for example, the maximum thickness of the EDLC 2 can be set to 1 mm or less, preferably 0.9 mm or less, more preferably 0.5 mm or less.

### Second Embodiment

As shown in FIG. 1B, an EDLC 2a of this embodiment is similar to the EDLC 2 of the first embodiment except for not having the support tabs 4f1 and 4f2 shown in FIG. 1A. Common members in the drawings are denoted by common reference numerals, and the description of common portions is omitted.

Moreover, in this embodiment, the front sheet 4a and the back sheet 4b have substantially the same length in the X-axis direction, and may be formed by folding the same piece of exterior sheet 4 or may be configured by separate sheets.

In this embodiment, the specified unevenness 180, 280 (the unevenness for which the spectral reflectance is in a specified range) is also formed on the surfaces of the lead terminals 18, 28. Therefore, the operation and effect similar to the first embodiment are obtained, and the connection reliability of the EDLC 2a can be improved.

### Third Embodiment

As shown in FIG. 2E, an EDLC 2b of this embodiment is similar to the EDLC 2 of the first embodiment except for having an insulation pedestal sheet 60. Common members in the drawings are denoted by common reference numerals, and the description of common portions is omitted.

As shown in FIG. 2E, preferably, the insulation pedestal sheet 60 is interposed between the lead terminals 18, 28 and the support tabs 4f1, 4f2. The insulation pedestal sheet 60 may be configured by a single-layer, or be configured by a multilayer of two layers or three or more layers. In any case, the insulation pedestal sheet 60 is not particularly limited as long as it is an insulating material such as a plastic film, synthetic paper or the like, and the insulation pedestal sheet 60 may be a material by which a predetermined thickness is maintained even under the applied heat and the pressure given by load and insulation is maintained accordingly.

When the insulation pedestal sheet 60 is industrially manufactured, polyethylene (PE) or polypropylene (PP) or the like is inexpensive and easily handled, but it is preferable to have a heat-resisting property. The insulation pedestal sheet 60 may be formed by polyethylene terephthalate (PET), poly methyl methacrylate (PMMA), polyvinyl alcohol (PVA), polycarbonate, polyimide, polyamide, polybutylene terephthalate and the like. In addition, even in the case of PE or PP, a stretched oriented polyethylene (OPE) and oriented polypropylene (OPP) are preferable because they are stretched in the vertical and horizontal directions during the manufacturing and are excellent in crystal orientation, and the heat-resisting property is improved compared with a CPP (extruded, casting PP) used as a sealing material. In addition, the insulation pedestal sheet 60 may also be a thermosetting resin such as polyurethane or epoxy resin. Elsewise, a film consisting of these composite materials may be used.

In this embodiment, it is preferable that the insulation pedestal sheet 60 is configured, for example, by a resin film having a three-layer structure, and it is preferable that a high melting point resin such as PET which is excellent in the heat-resisting property is arranged in a central part in the laminated direction, and a low melting point resin such as PP is laminated on the front surface (upper surface) and the back surface (lower surface) of the insulation pedestal sheet 60. The high melting point resin such as PET does not melt even during an ACF (anisotropic conductive film) connection or ACP (anisotropic conductive paste) connection and the thickness is maintained; PP melts and is heat-fused on the inner layer 4B of the back sheet 4b or the back surface of the lead terminal 18 or 28.

The insulation pedestal sheet 60 is bonded to and integrated with the inner layer 4B of the support tabs 4f1, 4f2 formed on the leading end part of the back sheet 4b extending in the X-axis direction by heat fusion, adhesion or the like. It is preferable that a thickness Z6 from the front surface (upper surface) of the insulation pedestal sheet 60 (the back surface of the lead terminal 18 or 28) to the metal sheet 4A of the back sheet 4b is equivalent to or larger than the second thickness Z2 of the above-described seal part 40 or 42. The reason is to facilitate the ACF (anisotropic conductive film) connection or ACP (anisotropic conductive paste) connection in a subsequent process and to reduce the load on the lead terminals.

Moreover, the insulation pedestal sheet 60 shown in FIG. 2E may be bonded to a predetermined location of the exterior sheet 4 before the element body 10 is sealed inside the exterior sheet 4, or may be arranged between the lead terminals 18, 28 and the support tabs 4f1, 4f2 after the sealing.

In this embodiment, the specified unevenness 180, 280 (the unevenness for which the spectral reflectance is in a specified range) is also formed on the surfaces of the lead terminals 18, 28. Therefore, the operation and effect similar to the first embodiment is obtained, and the connection reliability of the EDLC 2b can be improved.

In addition, in this embodiment, the insulation pedestal sheet 60 is provided between the lead terminals 18, 28 and the support tabs 4f1, 4f2, thereby a short-circuit failure between the metal sheet 4A of the exterior sheet 4 and the lead terminals 18, 28 or the like can be effectively prevented during the ACF (anisotropic conductive film) connection or ACP (anisotropic conductive paste) connection of the lead terminals 18, 28 and external connection terminals (not shown).

In addition, when the ACF or ACP is arranged on the lead terminals 18, 28, and the lead terminals 18, 28 are heated and pressurized to be connected to a pad (not shown) of the circuit substrate, the load applied to the lead terminals 18, 28 can be reduced and the damage of the lead terminals 18, 28 can be prevented.

### Fourth Embodiment

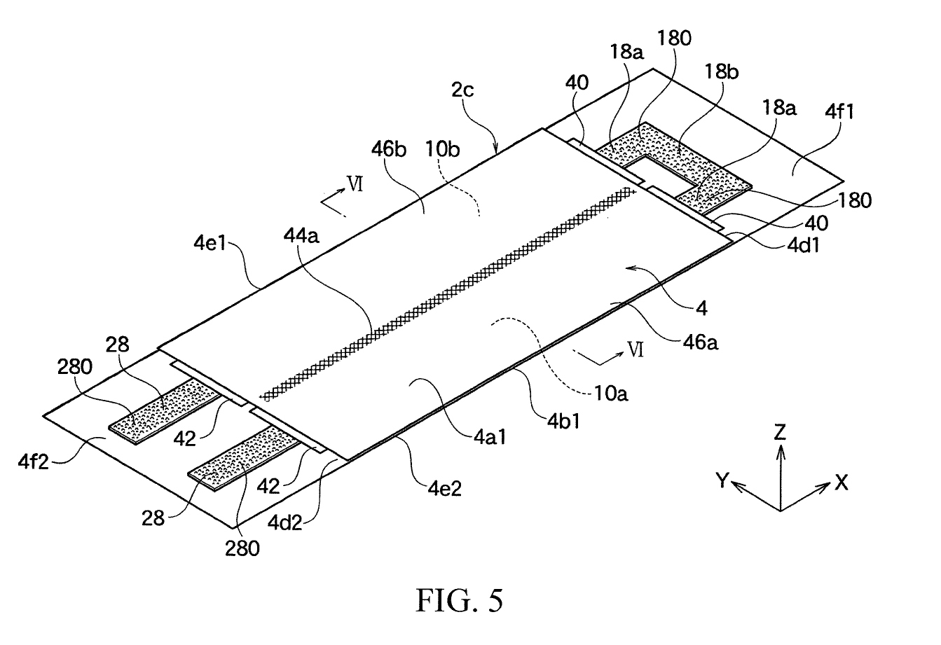

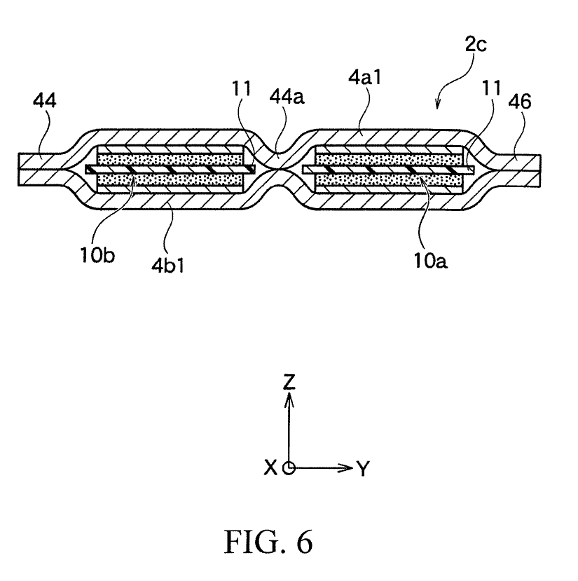

As shown in FIG. 5 and FIG. 6, in an EDLC 2c of this embodiment, two element bodies 10a, 10b are placed side by side in the Y-axis direction inside the exterior sheet 4. The other parts are similar to the first embodiment, and thus common members are denoted by common reference numerals in the drawings; in the following description, the description of common portions is partially omitted and different portions are described in detail.

In this embodiment, the exterior sheet 4 consists of a front sheet 4a1 and a back sheet 4b1, and is substantially twice as large as the exterior sheet 4 shown in FIG. 1A in the Y-axis direction. Inside the exterior sheet 4, as shown in FIG. 6, two element bodies 10a, 10b are housed, and the respective element bodies 10a, 10b respectively have a structure similar to the element body 10 of the first embodiment.

In this embodiment, the second lead terminals 28, 28 of the respective element bodies 10a, 10b are separately formed, but the respective first lead terminals 18a of the respective element bodies 10a, 10b are formed integrally with the connection part 18b and are continued with each other. That is, as shown in FIG. 5, the respective element bodies 10a, 10b are connected in series via the first lead terminals 18a and the connection part 18b. Moreover, in the example that is shown, a pair of first lead terminals 18a, 18a is connected in series via the connection part 18b, but the pair of first lead terminals 18a, 18a may also be directly and separately formed on the support tab 4f1 without arranging the connection part 18b.

A third seal part 44a is formed along the X-axis direction in the central part in the Y-axis direction of the exterior sheet 4, and the flow of electrolyte is separated between the element bodies 10a, 10b. A space for accommodating the element body 10a is sealed by the first seal part 40, the second seal part 42, the third seal part 44a and a fourth seal part 46a which are continuously formed on the exterior sheet 4, and filled with the electrolyte. Similarly, a space for accommodating the element body 10b is sealed by the first seal part 40, the second seal part 42, the third seal part 44a and the fourth seal part 46b which are continuously formed on the exterior sheet 4, and filled with the electrolyte.

In this embodiment, on the surfaces of the pair of first lead terminals 18a, 18a, the specified unevenness 180, 180 (the unevenness for which the spectral reflectance is in a specified range) is formed. Similarly, on the surface of the connection part 18b, the specified unevenness 180 (the unevenness for which the spectral reflectance is in a specified range) is formed. In addition, on the surface of the second lead terminal 28, the specified unevenness 280 (the unevenness for which the spectral reflectance is in a specified range) is formed. Therefore, in this embodiment, the operation and effect similar to the first embodiment is also obtained, and the connection reliability of the EDLC 2c can be improved.

In addition, in this embodiment, the lead terminals extending to the same side in the X-axis direction are connected in series or in parallel by a connection piece and the like, thereby the withstand voltage of the battery can be enhanced or the capacity can be increased. In addition, in this embodiment, the support tab 4f1 and 4f2 as shown in FIG. 1A are also provided, and thus bending of the lead terminals 28, 18a and the connection part 18b can be prevented effectively.

### Fifth Embodiment

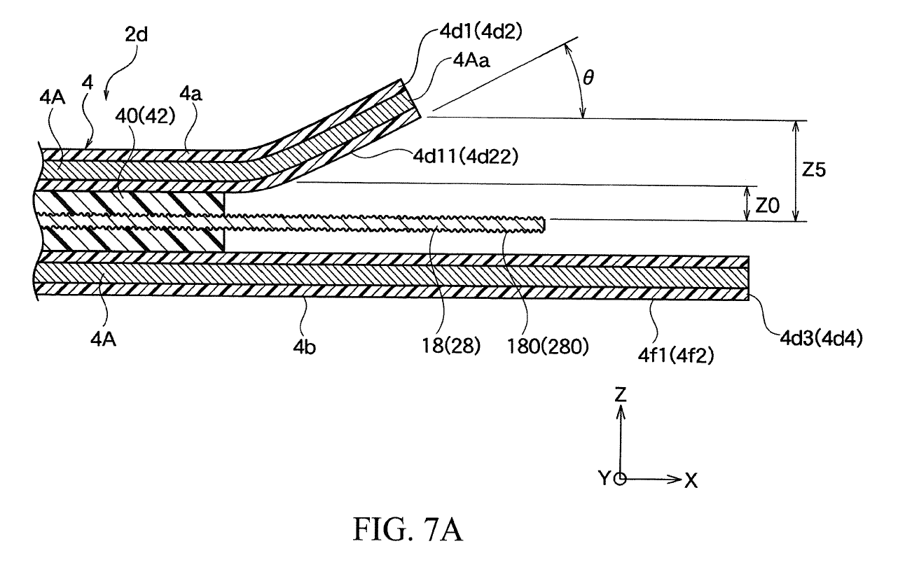

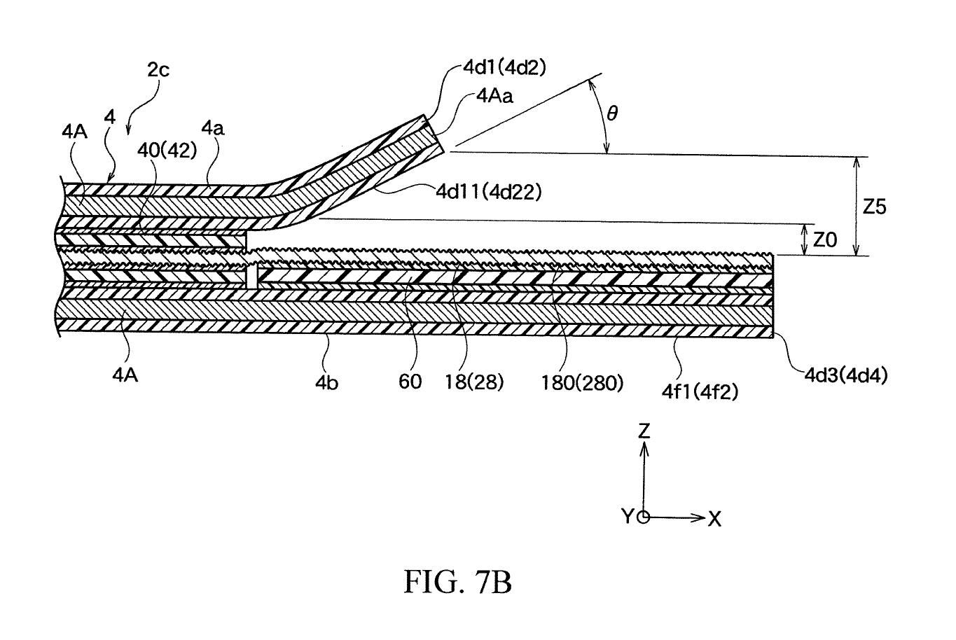

As shown in FIG. 7A, in an EDLC 2d of this embodiment, in a location where the respective lead terminals 18, 28 extend outward, the leading end parts 4d1, 4d2 of the front sheet 4a of the exterior sheet 4 are opened outward in a direction away from the lead terminals 18, 28 along the X-axis which is the extending direction of the lead terminals 18, 28. Apart from that, the EDLC 2d of this embodiment is similar to the EDLC 2 of the first embodiment. Common members are denoted by common reference numerals in the drawings, and the description of common portions is omitted.

As shown in FIG. 7A, in this embodiment, even if the leading end of the metal sheet 4A is exposed in the leading end parts 4d1, 4d2 of the front sheet 4a, a leading end clearance distance Z5 between the lead terminals 18, 28 and the exposed leading end 4Aa of the metal sheet 4A can be increased. Therefore, the short-circuit failure between the lead terminals 18, 28 and the exposed leading end 4Aa of the metal sheet 4A can be prevented effectively. Moreover, the leading end parts 4d1, 4d2 of the front sheet 4a are located inside of the leading end parts of the lead terminals 18, 28 in the X-axis direction along the extending direction of the lead terminals 18, 28. Therefore, the work for connecting the lead terminals 18, 28 to the external circuit is also easy.

That is, in this embodiment, compared with a minimum clearance distance Z0 (corresponding to Z1 or Z2 of the first embodiment) between the lead terminals 18, 28 and the metal sheet 4A in the locations corresponding to the seal parts 40, 42, the clearance distance Z5 between the lead terminals 18, 28 and the exposed leading end 4Aa of the metal sheet 4A projecting outside of the seal part 40 in the X-axis direction is larger. By this configuration, the short-circuit failure can be prevented effectively.

In addition, in this embodiment, an open angle θ of the leading end parts 4d1, 4d2 of the exterior sheet 4 with respect to the lead terminals 18, 28 is preferably 5 degrees or more and 70 degrees or less, more preferably 5-60 degrees. By this configuration, the short-circuit failure can be prevented more effectively, cracking is suppressed and a repeated bending resistance of EDLC 2d is improved.

In this embodiment, the specified unevenness 180, 280 (the unevenness for which the spectral reflectance is in a specified range) is also formed on the lead terminals 18, 28. Therefore, the operation and effect similar to the first embodiment is obtained, and the connection reliability of the EDLC 2d can be improved. Moreover, as shown in FIG. 7B, the EDLC 2d may be provided with the insulation pedestal sheet 60.

### Sixth Embodiment

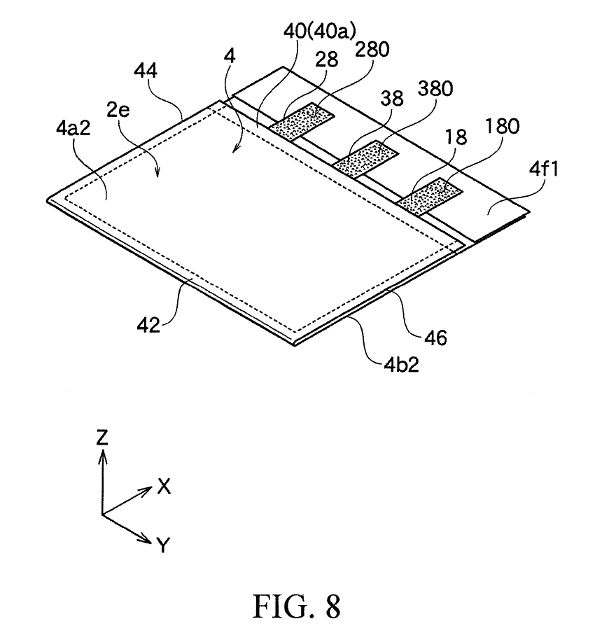

In the EDLCs of the above-described embodiments, the first lead terminal 18 and the second lead terminal 28 of the element body 10 extend to opposite sides along the longitudinal direction (X-axis direction) of the EDLC 2, 2a to 2d. However, as shown in FIG. 8, in an EDLC 2e of this embodiment, all of the first to third lead terminals 18, 28, 38 extend to only one side in the X-axis direction. Moreover, the third lead terminal 38 is depicted as a single terminal in FIG. 8, but the third lead terminal 38 is actually formed from two terminals laminated and extending outward. In addition, the two terminals constituting the third lead terminal 38 may be arranged deviated from each other in the Y-axis direction.

In the exterior sheet 4 of the EDLC 2e of this embodiment, one piece of sheet 4 is folded at the second seal part 42 to form the front sheet 4a2 and the back sheet 4b2. In this embodiment, a portion for sealing the peripheral part of the exterior sheet 4 where the lead terminals 18, 28, 38 extend outward in the X-axis direction is set as the first seal part 40. In addition, a sheet folded-back portion on the opposite side of the peripheral part of the exterior sheet 4 where the lead terminals 18, 28, 38 extend outward in the X-axis direction is set as the second seal part 42. Furthermore, portions for sealing two side peripheral parts of the exterior sheet 4 located on mutually opposite sides in the Y-axis direction are set as the third seal part 44 and the fourth seal part 46.

In this embodiment, a single or multiple sealing tapes 40a for forming the first seal part 40 is/are, similar to the above-described embodiments, partially heat fused to the inner surface of the exterior sheet 4, and the first seal part 40 is formed subsequently. Other configurations and the operation and effect of this embodiment are similar to the first to fourth embodiments, and thus common members are denoted by common reference numerals in the drawings, and the description of common portions is omitted.

In this embodiment, the specified unevenness 180, 280, 380 (the unevenness for which the spectral reflectance is in a specified range) are also formed on the lead terminals 18, 28, 38. Therefore, the operation and effect similar to the first embodiment is obtained, and the connection reliability of the EDLC 2e can be improved.

Moreover, the present invention is not limited to the above-described embodiments and can be variously modified within the scope of the present invention.

In the above embodiments, when the respective lead terminals 18, 28 are formed by conductive members different from the current collector layers 14, 24, the specified unevenness 180, 280 (the unevenness for which the spectral reflectance is in a specified range) may be only formed on the respective lead terminals 18, 28.

In the above embodiments, the specified unevenness 180, 280 (the unevenness for which the spectral reflectance is in a specified range) may be only formed on the upper or lower surfaces of the lead terminals 18, 28. In addition, on the upper and lower surfaces of the lead terminals 18, 28, the degree or the spectral reflectance of the unevenness 180, 280 may be different. For example, the spectral reflectance may be 70% or less according to the SCI method only on the upper surfaces of the lead terminals 18, 28 on which the ACF or ACP is arranged and to which the pad (not shown) of the circuit substrate is connected.

In addition, in the above embodiments, the specified unevenness 180, 280 (the unevenness for which the spectral reflectance is in a specified range) is formed on both the lead terminal 18 and the lead terminal 28, but the spectral reflectance may be 70% or less according to the SCI method only in any one of the two lead terminals. In addition, in the lead terminal 18 and the lead terminal 28, the degree of the unevenness 180, 280 or the spectral reflectance may be different.

In addition, in the above embodiments, the unevenness 180, 280 may be locally formed on the surfaces of the lead terminals 18, 28. For example, the unevenness 180, 280 may be formed around end parts in the X-axis direction of the lead terminals 18, 28 on which the ACF or ACP is arranged and to which the pad (not shown) of the circuit substrate is connected.

In addition, the sealing tapes 40a, 42a shown in FIG. 4A and so on are not limited to the single-layer resin tapes and may be tapes of multi-layer structure. For example, a tape of three-layer laminated structure may be used in which there is a high melting point resin (for example, PET) layer in the central part in the lamination direction and there are low melting point resin (for example, PP) layers on two surfaces thereof. By using the tapes 40a, 42a with this configuration, the sealing properties in the seal parts 40, 42 are further improved, and burrs are prevented by the high melting resin layer from penetrating even if the burrs are generated on the lead terminals 18, 28. Accordingly, the short-circuit failure in the seal parts 40, 42 can be prevented, and breakage of the lead terminals during thermo-compression bonding can be prevented effectively.

Furthermore, the laminated electrochemical device to which the present invention is applied can also be applied to a lithium battery or a lithium battery capacitor or the like without being limited to the EDLC. In addition, the specific shape or structure of the electrochemical device is not limited to the examples that are shown.

### EXAMPLES

In the following, the present invention is described in more detail based on examples, but the present invention is not limited to these examples.

### Example 1

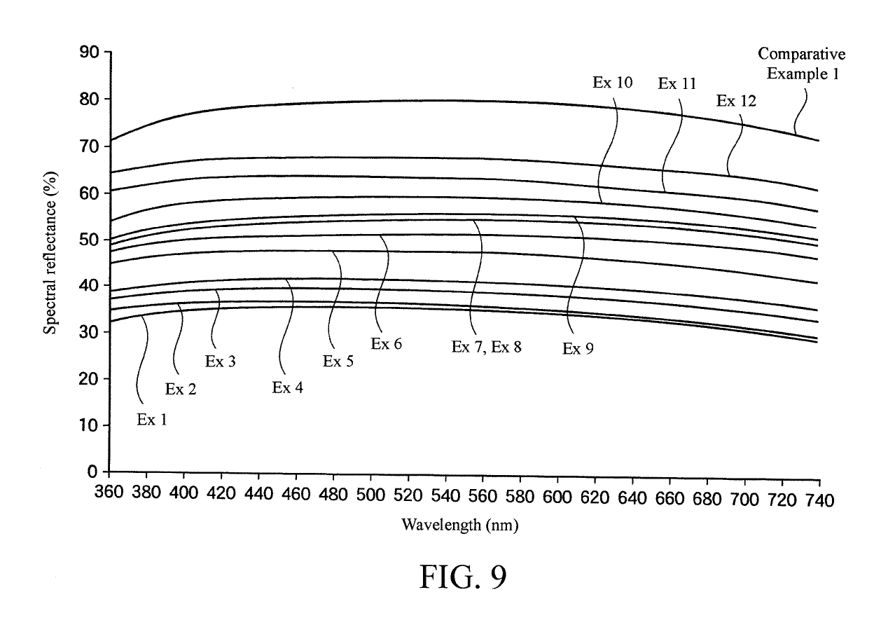

As shown in FIG. 1A, a sample of the EDLC 2 is manufactured in which the current collector layers 14, 24 of the inner electrodes 16, 26 are formed continuously and integrally with the lead terminals 18, 28. Aluminum foils are used as the lead terminals 18, 28 (the current collector layers 14, 24). The aluminum foils are immersed in an acidic etching solution to subject the surfaces to chemical etching, and the lead terminals 18, 28 are formed in which the unevenness 180, 280 is formed on the surfaces. When the spectral reflectance of the surfaces of the lead terminals 18, 28 is measured in a measurement wavelength of 360-740 nm using a spectral colorimeter (manufactured by Konica Minolta, SECTROPHOTOMETER CM-5), the spectral reflectance of the surfaces of the lead terminals 18, 28 is the value shown in Example 1 of FIG. 9 according to the SCI method. Moreover, Examples 1-12 are listed as “Ex 1” to “Ex 12” in FIG. 9.

An ACF material (manufactured by Hitachi Chemical Company, Ltd., MF-331) is arranged between the lead terminals 18, 28 of the manufactured sample of the EDLC 2 and the circuit substrate, the pressure of 3 MPa is applied at the temperature of 150° C. and heat pressurizing is performed for 10 seconds to connect the circuit substrate to the lead terminals 18, 28.

One hundred of the same samples are prepared and stored for a thousand hours under an environment of 85° C.-85% PH; the connection resistance between the lead terminals 18, 28 and the circuit substrate is measured, and a change rate from an initial value of the pre-measured connection resistance is calculated. In addition, the adhesion of the lead terminals 18, 28 with respect to the circuit substrate is measured, and a change rate from an initial value of the pre-measured adhesion is calculated. For the one hundred samples of Example 1, an average of the change rate of connection resistance and an average of the change rate of adhesion are obtained. The results are shown in Table 1. Moreover, the results when the spectral reflectance is measured in the measurement wavelength of 400 nm and 500 nm of the spectral colorimeter are typically shown in Table 1.

### Examples 2-5, 11

Except for changing the etching condition (shortening the etching time) from Example 1, the samples of the EDLC 2 are manufactured in the same manner as Example 1 and the same evaluation as Example 1 is conducted. The spectral reflectance of the surfaces of the lead terminals 18, 28 is the values shown in Examples 2-5, 11 of FIG. 9 according to the SCI method. The results are shown in Table 1.

### Examples 6, 7, 9, 10, 12

Except for applying, by using the calender roll, a predetermined pressure (100-1500 kg/cm) at room temperature to the aluminum foils subjected to etching treatment of Examples 2-5, 11, the samples of the EDLC 2 are manufactured in the same manner as Examples 2-5, 11 and the same evaluation as Examples 2-5, 11 is conducted. The spectral reflectance of the surfaces of the lead terminals 18, 28 is the values shown in Examples 6, 7, 9, 10, 12 of FIG. 9 according to the SCI method. The results are shown in Table 1.

### Example 8

Except for changing the pressure of the calender roll (a pressure lower than that of Example 7) and the temperature (a temperature higher than room temperature) from Example 7, the sample of the EDLC 2 is manufactured in the same manner as Example 7 and the same evaluation as Example 7 is conducted. The spectral reflectance of the surfaces of the lead terminals 18, 28 is the value shown in Example 8 of FIG. 9 according to the SCI method. The results are shown in Table 1.

### Comparative Example 1

Except that the surfaces of the aluminum foils are not subjected to chemical etching, the sample of the EDLC 2 is manufactured in the same manner as Example 1 and the same evaluation as Example 1 is conducted. The results are shown in Table 1. Moreover, the spectral reflectance of the surfaces of the lead terminals 18, 28 is the value shown in Comparative Example 1 of FIG. 9.

TABLE 1

| | Whether to | Spectral reflectance (%) | | Initial value | | Change rate | |
|---|---|---|---|---|---|---|---|
| | conduct | Measurement | Measurement | Resistance | Adhesion | Resistance | Adhesion |
| | etching | wavelength 400 nm | wavelength 500 nm | (Ω/mm²) | (N/cm) | (%) | (%) |
| Example 1 | Yes | 34 | 37 | 0.06 | 27 | 128 | 98 |
| Example 2 | Yes | 37 | 38 | 0.05 | 25 | 125 | 96 |
| Example 3 | Yes | 39 | 40 | 0.04 | 24 | 125 | 96 |
| Example 4 | Yes | 41 | 42 | 0.04 | 25 | 126 | 96 |
| Example 5 | Yes | 47 | 49 | 0.04 | 25 | 125 | 96 |
| Example 6 | Yes | 51 | 52 | 0.04 | 25 | 124 | 96 |
| Example 7 | Yes | 53 | 55 | 0.04 | 25 | 124 | 97 |
| Example 8 | Yes | 53 | 56 | 0.04 | 24 | 125 | 96 |
| Example 9 | Yes | 54 | 57 | 0.05 | 25 | 126 | 95 |
| Example 10 | Yes | 59 | 60 | 0.05 | 24 | 126 | 95 |
| Example 11 | Yes | 62 | 64 | 0.06 | 21 | 137 | 92 |
| Example 12 | Yes | 67 | 69 | 0.06 | 21 | 139 | 91 |
| Comparative | No | 78 | 81 | 0.03 | 18 | 210 | 85 |
| Example | | | | | | | |

Evaluation

As shown in Table 1, when the spectral reflectance of the surfaces of the lead terminals 18, 28 is, according to the SCI method, 67% or less in the measurement wavelength of 400 nm and 69% or less in the measurement wavelength of 500 nm, preferably 59% or less in the measurement wavelength of 400 nm and 60% or less in the measurement wavelength of 500 nm, particularly preferably 37% or more and 59% or less in the measurement wavelength of 400 nm and 38% or more and 60% or less in the measurement wavelength of 500 nm, it can be confirmed that the change rates of connection resistance and adhesion are good and the connection reliability is improved. In addition, when the spectral reflectance of the surfaces of the lead terminals 18, 28 is, according to the SCI method, 39% or more and 53% or less in the measurement wavelength of 400 nm and 40% or more and 56% or less in the measurement wavelength of 500 nm, it can be confirmed that the initial value of the connection resistance is low and the connection reliability is particularly improved.

### REFERENCE SIGNS LIST

2, 2a, 2b, 2c, 2d: electric double layer capacitor (EDLC)

4: exterior sheet

4a, 4a1: front sheet

4b, 4b1: back sheet

4c: folded-back peripheral part

4d1-4d4: leading end part

4d11, 4d22: opening portion

4e: side peripheral part

4f1, 4f2: support tab

4A: metal sheet

4Aa: exposed leading end

4B: inner layer

4C: outer layer

10: element body

11: separator sheet

12: first active layer

14: first current collector layer

16: first inner electrode

18, 18a: first lead terminal

18b: connection part

180: unevenness

22: second active layer

24: second current collector layer

26: second inner electrode

28: second lead terminal

280: unevenness

38: third lead terminal

380: unevenness

40: first seal part

42: second seal part

44: third seal part

46: fourth seal part

60: insulation pedestal sheet

What is claimed is:

1. An electrochemical device comprising: an element body in which a pair of inner electrodes are arranged so as to sandwich a separator sheet;
an exterior sheet covering the element body;
seal parts sealing peripheral parts of the exterior sheet for immersing the element body in an electrolyte; and
lead terminals extending outward from the seal parts of the exterior sheet;
wherein at least one surface of the lead terminals is etched to form unevenness.

2. The electrochemical device according to claim 1, wherein at least one surface of the lead terminals is chemically etched.

3. The electrochemical device according to claim 1, wherein the lead terminals are formed by aluminum or an aluminum alloy.

4. The electrochemical device according to claim 1, wherein current collector layers of the inner electrodes are formed continuously and integrally with the lead terminals.

5. The electrochemical device according to claim 1, wherein a thickness of the lead terminals is 60 μm or less.

6. The electrochemical device according to claim 1, further comprising support tabs which are comprised of a portion of the peripheral parts of the exterior sheet extending outwardly from the seal parts to the outside.

7. An electrochemical device comprising: an element body in which a pair of inner electrodes are arranged to sandwich a separator sheet;
an exterior sheet covering the element body;
seal parts sealing peripheral parts of the exterior sheet for immersing the element body in an electrolyte; and
lead terminals extending outward from the seal parts of the exterior sheet;
wherein spectral reflectance of at least one surface of the lead terminals is 70% or less according to a SCI method.

8. The electrochemical device according to claim 7, wherein at least one surface of the lead terminals is chemically etched.

9. The electrochemical device according to claim 7, wherein the lead terminals are formed by aluminum or an aluminum alloy.

10. The electrochemical device according to claim 7, wherein current collector layers of the inner electrodes are formed continuously and integrally with the lead terminals.

11. The electrochemical device according to claim 7, wherein a thickness of the lead terminals is 60 μm or less.

12. The electrochemical device according to claim 7, further comprising support tabs which are comprised of a portion of the peripheral parts of the exterior sheet extending outwardly from the seal parts to the outside.
